(19) United States
(12) Patent Application Publication
(10) Pub. No.: US 2026/0366456 A1
(43) Pub. Date: Nov. 19, 2026

(54) Rotary Torque Generator

(71) Applicant: EMILIA SIMONA APOSTOL, WARWICK (GB)

(72) Inventor: EMILIA SIMONA APOSTOL, WARWICK (GB)

(21) Appl. No.: 19/253,796

(22) Filed: Jun. 28, 2025

(30) Foreign Application Priority Data
May 17, 2025 (GB) 2507633.2

(51) Int. Cl. F02B 75/22; F02B 53/02; F02M 21/02

(52) U.S. Cl. CPC F02B 75/222; F02B 53/02; F02M 21/0206; F02B 2201/04

(57) ABSTRACT

A rotary torque generator comprising a fixed eccentric element, a plurality of levers, and constant volume combustion chambers mechanically coupled to a rotating disc. Each lever includes a three-rod linkage: a first rod connected to the combustion chamber, a second rod coupled via a mobile fulcrum, and a third rod pivotally attached to the eccentric element. The combustion chambers are configured to move along a stator surface that defines active and inactive zones. During operation, pressure generated by combustion in the active zone actuates the lever mechanism, transmitting force to the rotating disc and producing torque. Exhaust occurs as the chamber passes an outlet port in the inactive zone, followed by recharging. The design eliminates reciprocating pistons, crankshafts, and internal gears, enabling continuous rotary output from discrete pressure events. The system is compatible with hydrogen and other combustible gaseous fuels.

### CROSS-REFERENCE TO RELATED APPLICATIONS

This application claims the benefit of priority to United Kingdom patent application no. GB2507633.2, filed on May 17, 2025, the entire contents of which are hereby incorporated by reference.

### TECHNICAL FIELD

The present invention relates to energy conversion systems, and more particularly to rotary mechanisms configured for the efficient transformation of chemical energy from combustion into rotational mechanical output. The invention is particularly suited for operation with hydrogen fuel and addresses specific technical challenges associated with hydrogen combustion, including rapid flame propagation, ignition control, and nitrogen oxide (NOx) emission mitigation. Although optimized for hydrogen, the invention is broadly applicable to a range of combustible gaseous fuels, and may be employed in scalable, low-emission power generation systems, including decentralized energy infrastructure, backup power units, and hydrogen-based energy applications.

### BACKGROUND OF THE INVENTION

Conventional internal combustion engines (ICEs), including those based on reciprocating piston-crank mechanisms and rotary vane-type configurations, have historically been optimized for the combustion of fossil fuels. The adaptation of such systems for use with hydrogen presents several technical challenges due to hydrogen's distinct physical and chemical properties, including high flame speed, low ignition energy, and high diffusivity.

These challenges are compounded by inherent limitations of traditional ICE architectures, such as reciprocating mass, mechanical complexity, the need for compression strokes, and non-ideal combustion chamber dynamics. These factors contribute to increased frictional losses, mechanical wear, suboptimal combustion control, and elevated nitrogen oxide (NOx) emissions—issues that become more pronounced during hydrogen combustion.

Various approaches have been proposed to improve the conversion of combustion energy into rotational motion. For example, wave rotor-based systems, such as that disclosed in US20130327010A1, utilize pressure waves within rotating components to achieve energy transfer. However, such designs often rely on shockwave behavior and intricate channel geometries, making them sensitive to flow conditions and difficult to scale for robust hydrogen-fueled applications.

Other prior art includes rotary engines incorporating sliding vanes or reciprocating pockets, such as those disclosed in GB122755A and JP5213009A. These designs often require cams, cranks, and compression mechanisms, increasing mechanical complexity and limiting constant torque output. Similarly, lever-based rotary combustion mechanisms, such as the system described in RO131736A2, utilize multiple interconnected gears to transfer force to the output shaft. While functionally novel, the gearing introduces additional mechanical losses and complicates chamber sealing, particularly under the high-pressure conditions of hydrogen combustion. Moreover, the resulting chamber trajectories in such geared systems can be dynamically irregular, making it difficult to maintain a stable sealing interface between the mobile chamber and the stator surface throughout the rotation cycle.

The present invention seeks to address these limitations by eliminating internal gearing and enabling a simplified mechanical architecture. In the disclosed system, combustion chambers follow a controlled, near-circular path along the stator. While not perfectly circular, the trajectory is mechanically smoother than those in prior geared systems, facilitating more consistent sealing and combustion timing. This configuration improves manufacturability and operational stability, particularly in hydrogen-fueled applications.

Earlier conceptual versions of the invention were the subject of withdrawn UK patent applications. The current disclosure represents a refined and independently developed system, based on further mechanical optimization and experimental validation.

There remains a need for a rotary torque generation mechanism capable of converting constant volume combustion into smooth, continuous rotary output without the use of reciprocating components, internal gear trains, or complex thermodynamic cycles. Such a system should also support effective thermal management, simplified construction, and high efficiency, particularly for applications in hydrogen-fueled energy systems and low-emission backup power generation.

The present invention addresses these needs by providing a rotary torque generator that employs direct lever-stator interaction, enabling constant volume combustion and continuous torque delivery in a scalable, mechanically simplified configuration.

### SUMMARY OF THE INVENTION

The present invention provides a rotary torque generation system configured to convert pressure-based energy—such as that produced by constant volume combustion—into continuous rotational mechanical output through a simplified, mechanically efficient architecture.

The system comprises one or more pressure chambers, which in a preferred embodiment are constant volume combustion chambers (CVCCs), operatively mounted to a set of levers. Each lever is pivotally connected to a fixed eccentric shaft and configured to transmit force to a rotating disc as the combustion chamber moves along a guided path defined by the inner surface of a stationary stator.

During operation, combustion of a gaseous fuel-air mixture within a sealed combustion chamber generates a pressure rise under near-constant volume conditions. This pressure acts on the internal walls of the chamber and is mechanically redirected through the lever-linkage assembly. Due to the asymmetric configuration of the lever and the eccentric placement of the pivot, the applied force induces a consistent rotational torque on the output shaft. The linkage geometry is configured such that torque amplification occurs progressively throughout the combustion stroke.

Exhaust gases are expelled as the combustion chamber rotates into alignment with an exhaust port in the stator. The pressure differential between the chamber and ambient atmosphere enables passive ejection of combustion products without the need for reciprocating pistons or forced scavenging systems. Subsequent chamber motion past an intake port enables recharging of the combustion volume for the next ignition cycle.

In contrast to certain prior rotary engines that employ crankshafts, compression strokes, or gear trains to convert combustion pressure into rotary motion, the present invention utilizes a direct lever-stator interface to produce continuous rotation. The movement of each combustion chamber follows a controlled, near-circular trajectory, which supports consistent chamber sealing and simplified ignition timing. The mechanical arrangement reduces internal friction and improves thermal management by spatially isolating heat-affected zones from moving components.

The system is modular and may be scaled by varying the number of combustion chambers, levers, or rotating assemblies. It is particularly applicable to hydrogen-fueled combustion systems, as it addresses key challenges including flame speed control, hotspot mitigation, and nitrogen oxide (NOx) emissions. Additional applications may include backup power units, mobile energy platforms, and decentralized or distributed energy systems.

### BRIEF DESCRIPTION OF THE DRAWINGS

FIG. 1 is a front-perspective view of the apparatus as seen from a plane perpendicular to the output drive shaft.

FIG. 2 is a side view in a plane parallel to the output drive shaft showing the lever assemblies and the rotary disc relative to the stator, with the offset between the drive shaft and the eccentric.

FIG. 3 is an isometric view showing the rotating components and the stator rail.

FIG. 4 is a cross-sectional view of the lever assembly taken in a plane perpendicular to the output drive shaft, with the second rotary disc and the drive shaft omitted for clarity.

FIG. 5 is a tilted three-quarter view showing the stator from side and rear perspectives.

### DETAILED DESCRIPTION OF THE INVENTION

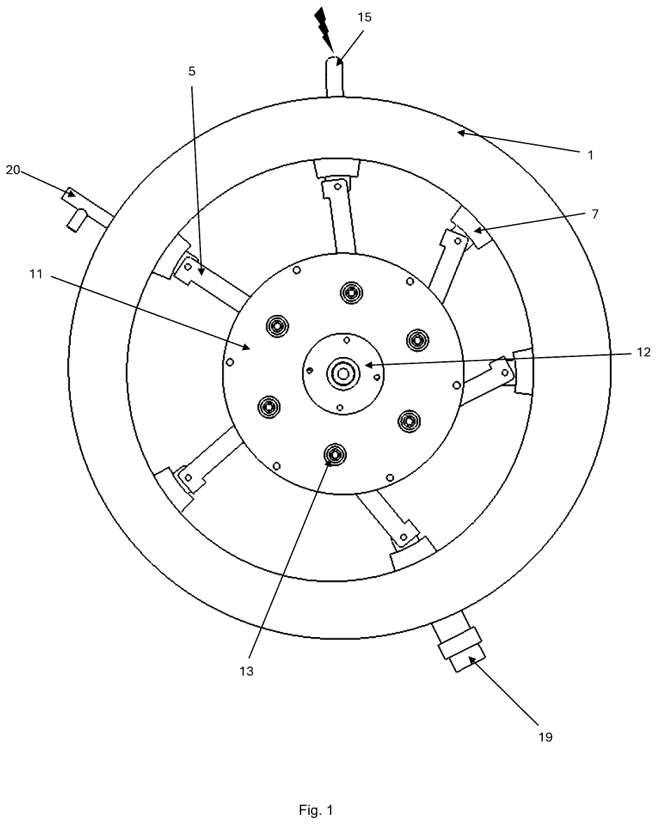

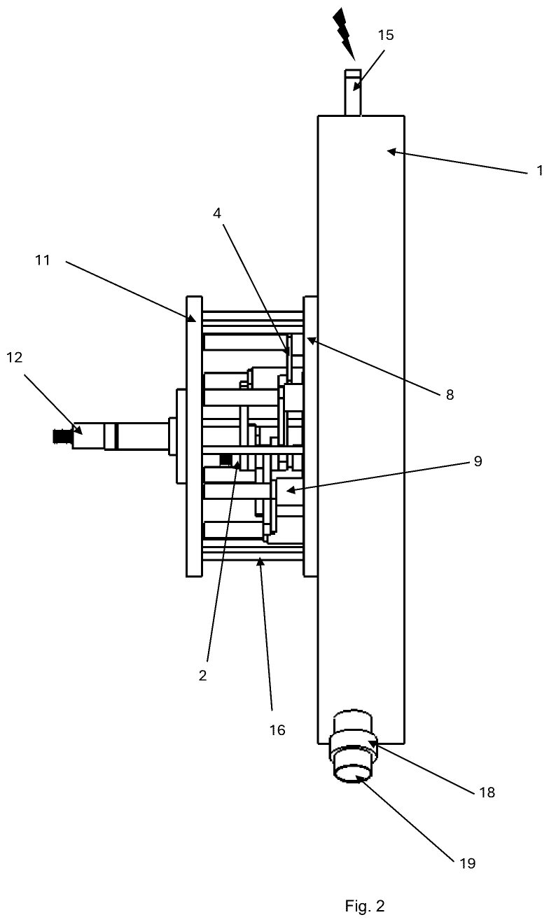

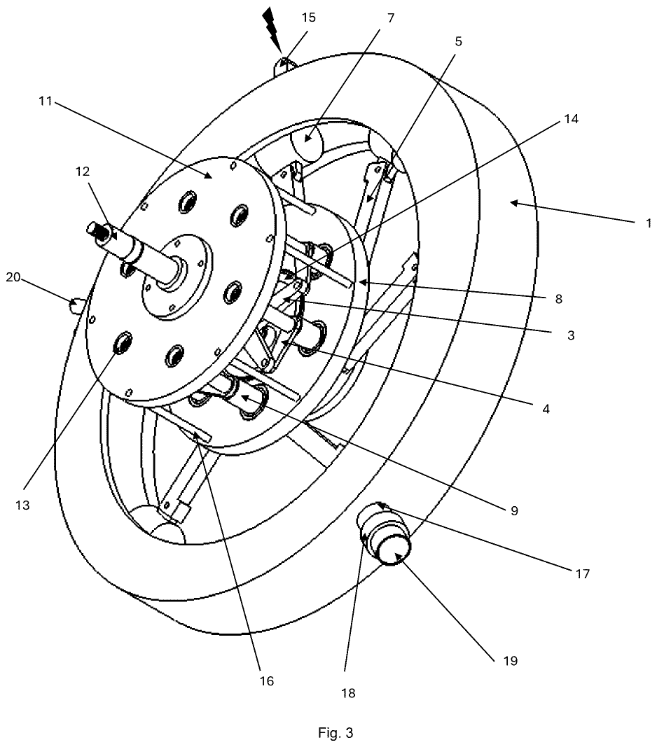

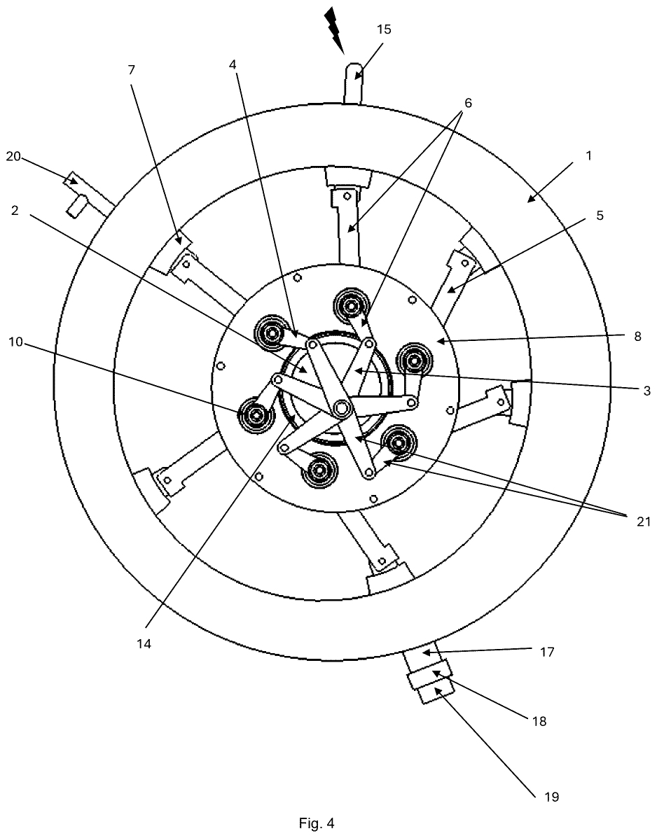

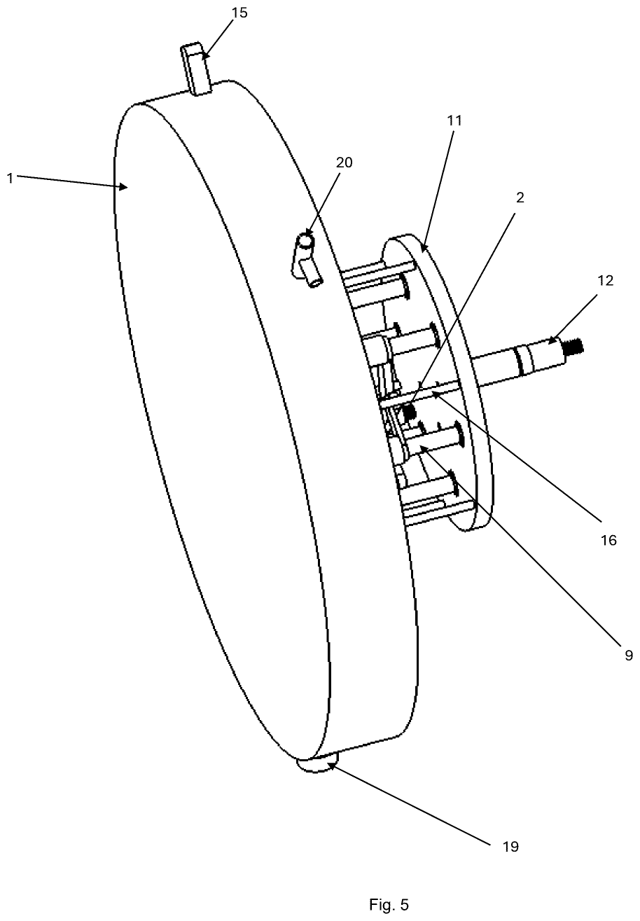

The present invention relates to a rotary torque generator that converts force generated from a pressurized fluid medium, such as from combustion or an external pressure source, into continuous rotational output using a novel lever-stator mechanism. While particularly applicable as an internal combustion engine utilizing constant volume combustion chambers (CVCCs) and various fuels including hydrogen, the invention may also be adapted for hydro, wind, or other fluid-driven mechanical power generation where the pressure chambers are supplied by an external source. A specific embodiment, optimized for internal combustion, is described below with reference to FIGS. 1-5.

### General Overview

The mechanism includes a stator (1), a rotating output shaft (12), and a rotary assembly comprising two coaxial discs (8, 11), which rotate in a plane perpendicular to the drive shaft. The rotational motion of the output shaft is derived from the movement of levers connected to combustion chambers that interact with the stator.

In the illustrated embodiment, six sets of levers are used to generate continuous torque, with combustion events cyclically distributed around the shaft axis. The configuration ensures that multiple chambers are in the active zone at all times, maintaining constant torque output.

### Structural Arrangement

As shown in FIGS. 1 through 5, the stator (1) functions as the fixed structural frame of the system. An eccentric pivot (2), rigidly mounted to the stator and offset from the drive shaft axis, serves as a fixed rotational anchor for the articulated linkage system.

A first rotary disc (8) is mounted on the stator via a bearing (14), allowing free rotation around the central axis. This disc is mechanically coupled to a second rotary disc (11), which is rigidly connected to the output shaft (12). The two discs are linked using a set of fixing pins (16), ensuring synchronous rotation. As the first disc (8) turns, it drives the second disc (11), transmitting torque directly to the output shaft (12).

Each actuation module includes a three-rod linkage consisting of Rods (3), (4), and (5). Rod (5) is the force-receiving member, connected to the constant volume combustion chamber (CVCC) (7), and transmits combustion-induced force into the linkage system. Rod (4) connects to both Rod (5) and Rod (3), forming a compound linkage. The angle between Rods (5) and (4) is fixed, determined by the rigid configuration of their joint. In contrast, the angle between Rods (4) and (3) varies dynamically during operation, evolving as the linkage rotates and the chamber progresses through the active zone.

Rod (3) is anchored to the eccentric pivot (2), while Rod (4) is supported by a mobile shaft (9) via a bearing (10), which is connected to the rotating disc (8). The coordinated motion of these linked rods causes the first disc (8) to rotate in response to the linear input from Rod (5). The system's geometry converts short-duration linear impulses into smooth, continuous rotational output. This configuration ensures efficient transfer of combustion pressure into usable torque, with torque amplification and rotation direction governed by the changing angle between Rods (3) and (4).

### Combustion and Force Generation

In one embodiment of the rotary torque generator configured as an internal combustion engine, each first rod (5) supports a pressure chamber (7), specifically configured as a constant volume combustion chamber (CVCC), which slides along the internal surface of the stator (1). Friction at the interface is managed either through precision tolerances or lubrication techniques similar to those used in conventional piston-cylinder assemblies. A spring-loaded or compliant sealing mechanism is integrated into the chamber-stator interface to ensure continuous gas-tight contact along the chamber's non-circular trajectory.

An injection nozzle (20) positioned in the stator supplies each combustion chamber with either a pre-mixed air-fuel charge or separate air and fuel streams. Ignition is triggered by a spark plug (15), also fixed in the stator and aligned to ignite the mixture when the chamber reaches the designated ignition zone. This fixed positioning avoids the need for electrical connections to moving components, simplifying the ignition system and increasing its durability.

Due to the relatively compact geometry and fixed volume of each combustion chamber, a single spark plug is sufficient to ensure complete and uniform flame propagation. Rotary engines such as the Wankel typically require dual ignition points due to their extended combustion chamber geometry; in contrast, the present configuration enables stable and efficient combustion using a single ignition source per chamber.

When combustion occurs, the rapidly rising pressure within the sealed CVCC (7) acts against the stator and applies a linear force to rod (5). This force propagates through the first lever set (6), causing the first rotary disc (8) to rotate around the central shaft. The rotation of the first disc is mechanically transmitted to the second disc (11), which is coupled to the output shaft (12), generating useful rotary output.

As the chamber continues through the active zone, the geometry of the linkage (21)—formed by rods (3) and (4)—evolves. Specifically, the angle between rod (3), which is anchored to the eccentric pivot (2), and rod (4) gradually narrows. This dynamic shift alters the force vector transmitted to the rotating disc, improving the mechanical leverage as the stroke progresses. As a result, a progressively increasing portion of the input force is redirected tangentially to the disc's rotation path, resulting in effective torque amplification. This geometry allows short-duration pressure pulses to produce smooth and forceful rotary motion across the full stroke.

Crucially, the direction of this angular narrowing also causes the applied force to resolve into consistent unidirectional rotation—ensuring that the mechanism turns in the correct (clockwise) direction after each combustion event. This geometric interaction not only amplifies torque but also governs the rotational direction of the output.

After the combustion event, the chamber enters the exhaust phase, aligning with an exhaust port (17). The residual gases are expelled through this port due to the remaining pressure differential between the combustion chamber and ambient atmosphere. This contributes to chamber scavenging and prepares the chamber for the next cycle.

As the chamber continues its rotation and passes into the intake zone, its internal pressure may drop below ambient due to the momentum of gas outflow and the rapid volumetric change imposed by the lever geometry. This transient negative pressure—created by expansion dynamics and the absence of backpressure—can facilitate passive induction of the incoming air-fuel mixture through the intake port, improving filling efficiency without requiring forced induction.

A muffler (18) is connected downstream of the exhaust port to reduce acoustic emissions, and the combustion products exit the system as exhaust gas (19).

The stator path is functionally divided into two regions: the active zone, where combustion and torque generation occur, and the inactive zone, where intake and exhaust take place. This phasing ensures that combustion occurs when the linkage configuration provides optimal torque transmission, enhancing the overall mechanical efficiency and power output of the engine.

Although this embodiment utilizes chemical energy from combustion to produce pressure, the same stator-linkage architecture may be driven by any high-pressure fluid medium, enabling the system to function as a general-purpose rotary actuator across a variety of energy domains.

### Efficiency and Cooling

The CVCC remains at constant volume during ignition, enabling better combustion control and avoiding incomplete burning. This structure eliminates the need for a compression stroke and avoids dead-center limitations typical in piston engines. The angular relationship between force application and lever motion remains favorable throughout the active zone, contributing to consistent torque output.

Furthermore, because pistons are absent, the heat generated during combustion remains concentrated in the chamber (7), which is spatially isolated from the rest of the assembly. This enables better thermal management, reduces the risk of premature ignition due to hotspot accumulation, and supports reduced NOx formation during hydrogen combustion. The constant volume combustion process also facilitates the use of lean hydrogen-air mixtures, which burn more cleanly and further suppress NOx emissions due to lower peak flame temperatures.

Cooling is managed by optional fluid channels or air fins located along the stator adjacent to the combustion trajectory.

These thermal and mechanical advantages are particularly well suited for hydrogen combustion but remain beneficial for any working fluid that undergoes rapid pressurization.

### Lever Configuration and Modularity

The illustrated embodiment uses six sets of levers and combustion chambers arranged radially. Each third rod (3) is positioned axially along the drive shaft, while rods (4) are configured to converge at shared shafts (9) to maintain coplanarity of the first rods (5). The result is a compact, radially symmetric mechanism that ensures at least two chambers are active at any given time.

This system requires a minimum of two combustion chambers for continuous torque, but any even number may be implemented depending on performance requirements. The system is modular and scalable.

### Alternative Applications

Although the system is described herein primarily in the context of internal combustion-based energy conversion, the same mechanical architecture is also applicable to non-combustion energy sources. In alternative embodiments, rotational motion may be generated by applying pressure impulses from external fluid sources-such as compressed air or water-directly to rod (5) within the active region. In such configurations, the system may function as a fluid-driven rotary actuator.

These embodiments may be utilized in hydroelectric turbines, wave energy converters, pneumatic systems, or other pressure-based energy harvesting applications. The underlying lever-stator mechanism remains unchanged, enabling scalable and mechanically simplified energy conversion from a variety of pressure-driven sources.

1. A rotary torque generator comprising:
(a) a fixed eccentric element;
(b) a plurality of levers, each lever including:
(i) a first rod connected to a constant-volume pressure or combustion chamber,
(ii) a second rod connected to the first rod by a mobile fulcrum, and
(iii) a third rod pivotally connected to the second rod and to the fixed eccentric element;
(c) a mobile fulcrum configured to link the first and second rods;
(d) a rotary disc mounted on the eccentric element by a bearing and coupled directly to an output shaft; and
(e) a stator defining a guiding surface along which each pressure chamber moves on a substantially near-circular trajectory, wherein torque is generated directly through lever-stator interaction without the use of internal gear trains or crankshafts, the near-circular trajectory maintaining a continuous sealing interface between each pressure chamber and the stator surface and permitting a greater number of lever-chamber assemblies to be arranged around the eccentric element within a given device diameter, thereby increasing power density relative to geared rotary mechanisms.

2. The rotary torque generator of claim 1, wherein the stator defines an active zone in which pressure is applied within each pressure chamber to drive the corresponding lever, and an inactive zone in which each pressure chamber is vented or refilled, such that alternating engagement of the chambers within the active zone produces continuous rotational torque on the output shaft.

3. The rotary torque generator of claim 2, wherein each constant-volume combustion chamber is configured for operation with hydrogen fuel, the chamber geometry and ignition arrangement being selected to promote stable combustion, high flame-speed utilisation, and reduced formation of nitrogen oxides.

4. The rotary torque generator of claim 3, wherein each pressure chamber is configured to receive a pressurised working fluid supplied from an external source, the fluid being selected from air, water, or another high-pressure medium, such that the applied fluid pressure within the active zone drives the corresponding lever to generate rotary torque on the output shaft.

5. The rotary torque generator of claim 4, wherein an angle between the first rod and the second rod remains fixed during operation, such that the first and second rods act as a rigid assembly to transmit pressure-induced force from the pressure chamber to the mobile fulcrum with minimal mechanical loss.

6. The rotary torque generator of claim 5, wherein an angle between the second rod and the third rod varies during operation, the variation being configured to increase mechanical advantage as each pressure chamber passes through the active zone, thereby enhancing torque output while maintaining smooth rotary motion.

7. The rotary torque generator of claim 6, wherein the stator guiding surface is shaped and finished to maintain a continuous sealing interface with each pressure chamber along its near-circular trajectory, thereby reducing leakage, reducing frictional wear and improving operational efficiency and durability.

8. The rotary torque generator of claim 7, wherein an ignition source is mounted on the stator and aligned with each combustion chamber along the active zone, the ignition source being configured to initiate combustion at a predetermined chamber position to ensure synchronised pressure generation and consistent torque output.

9. The rotary torque generator of claim 8, comprising a plurality of rotary modules arranged coaxially along a common output shaft, each module including a corresponding set of levers and pressure chambers mounted around a fixed eccentric element, such that the torque contributions of the modules combine additively to increase total rotary output in a modular and scalable configuration.

10. The rotary torque generator of claim 9, wherein the absence of gear trains and crankshafts permits an increased number of lever assemblies to be arranged radially about the eccentric element, thereby providing enhanced power density for a given device diameter.

11. The rotary torque generator of claim 10, wherein elimination of gears and crankshafts reduces frictional and transmission losses, thereby simplifying maintenance and improving operational reliability.

12. The rotary torque generator of claim 11, wherein the substantially near-circular trajectory of the lever ends improves mechanical efficiency and reduces vibration during operation.

13. The rotary torque generator of claim 12, further comprising a control system configured to synchronise pressure application or ignition timing with the position of each pressure chamber along the stator surface, thereby optimising torque generation and combustion efficiency.

14. The rotary torque generator of claim 13, wherein the stator or pressure chambers include cooling passages or thermal insulation features configured to maintain uniform operating temperature and prevent overheating during continuous operation.

15. The rotary torque generator of claim 14, wherein the stator guiding surface and chamber seals include low-friction coatings or lubrication channels configured to minimise wear and extend service life.

16. The rotary torque generator of claim 15, wherein the output shaft is operatively connected to an electrical generator or energy recovery system for hybrid or regenerative operation.

17. A hybrid power system comprising:
(a) a rotary torque generator according to claim 1;
(b) an electric generator coupled to the output shaft; and
(c) an energy storage or management system configured to distribute electrical power to a maritime vessel, off-highway vehicle, or industrial installation,
wherein the rotary torque generator operates using a carbon-free or low-carbon fuel to provide a sustainable power source in applications that are difficult to electrify using conventional technologies.

18. A method of generating rotary torque, the method comprising:
(a) applying pressure within a constant-volume pressure or combustion chamber connected to a first rod of a lever mechanism;
(b) transmitting force from the first rod through a mobile fulcrum to a second rod;
(c) pivoting a third rod, connected to the second rod, about a fixed eccentric element;
(d) rotating a rotary disc mounted on the eccentric element and coupled directly to an output shaft;
(e) controlling relative angles between the rods such that an angle between the first and second rods remains fixed while an angle between the second and third rods varies to increase mechanical advantage through an active zone; and
(f) producing torque on the output shaft directly through lever-stator interaction without the use of internal gear trains or crankshafts,
whereby the lever ends follow a substantially near-circular trajectory along a stator surface that maintains a continuous sealing interface with each pressure chamber.

19. The method of claim 18, wherein the pressure within each constant-volume combustion chamber is generated by combustion of hydrogen fuel mixed with air, the hydrogen being ignited by a stator-mounted ignition source to produce rapid combustion with reduced nitrogen-oxide formation and improved thermal efficiency.

20. The method of claim 18, wherein the pressure applied within each pressure chamber is provided by an external pressurised-fluid source, the fluid being selected from air, water, or another high-pressure working medium, such that the fluid pressure acts on the first rod to drive the lever mechanism and generate rotary torque without internal combustion.

21. The method of claim 18, wherein the steps are performed concurrently across multiple lever-chamber assemblies arranged in radial symmetry around the fixed eccentric element, or across a plurality of rotary modules connected coaxially along the same output shaft, such that the individual torque contributions combine additively to produce a continuous and balanced rotary output.

22. A method of decarbonising power generation, the method comprising:
(a) operating a rotary torque generator comprising a gearless lever-stator mechanism configured for pressure-driven torque generation;
(b) coupling the generator to an electrical generator or drivetrain; and
(c) operating the rotary torque generator using a hydrogen-based or renewable fuel, thereby reducing carbon dioxide emissions relative to an equivalent diesel engine system.
